(19) United States
(12) Patent Application Publication
(10) Pub. No.: US 2019/0344697 A1
(43) Pub. Date: Nov. 14, 2019

(54) BEVERAGE WARMING ASSEMBLY

(71) Applicant: Cristos Stefos, Tarpon, FL (US)

(72) Inventor: Cristos Stefos, Tarpon, FL (US)

(21) Appl. No.: 15/974,691

(22) Filed: May 9, 2018

(51) Int. Cl. B60N 3/10; A47J 36/24

(52) U.S. Cl. CPC B60N 3/104; B60N 3/16; A47J 36/2483

(57) ABSTRACT

A beverage warming assembly for heating a beverage container in a vehicle includes a receptacle that is positioned within a vehicle for insertably receiving a beverage container. A heating coil is coupled to the receptacle and the heating coil is in thermal communication with the receptacle. The heating coil is fluidly coupled to a cooling system of the vehicle such that the heating coil receives a heated fluid from the cooling system. In this way the heating coil may heat the beverage container when the beverage container is positioned in the receptacle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to warming devices and more particularly pertains to a new warming device for heating a beverage container in a vehicle.

### BRIEF SUMMARY OF THE INVENTION

An embodiment of the disclosure meets the needs presented above by generally comprising a receptacle that is positioned within a vehicle for insertably receiving a beverage container. A heating coil is coupled to the receptacle and the heating coil is in thermal communication with the receptacle. The heating coil is fluidly coupled to a cooling system of the vehicle such that the heating coil receives a heated fluid from the cooling system. In this way the heating coil may heat the beverage container when the beverage container is positioned in the receptacle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a beverage warming assembly according to an embodiment of the disclosure.

FIG. 2 is a perspective in-use view of an embodiment of the disclosure.

FIG. 3 is a bottom phantom view of an embodiment of the disclosure.

FIG. 4 is a top view of an embodiment of the disclosure.

FIG. 5 is a cross sectional view taken along line 5-5 of FIG. 4 of an embodiment of the disclosure.

### DETAILED DESCRIPTION OF THE INVENTION

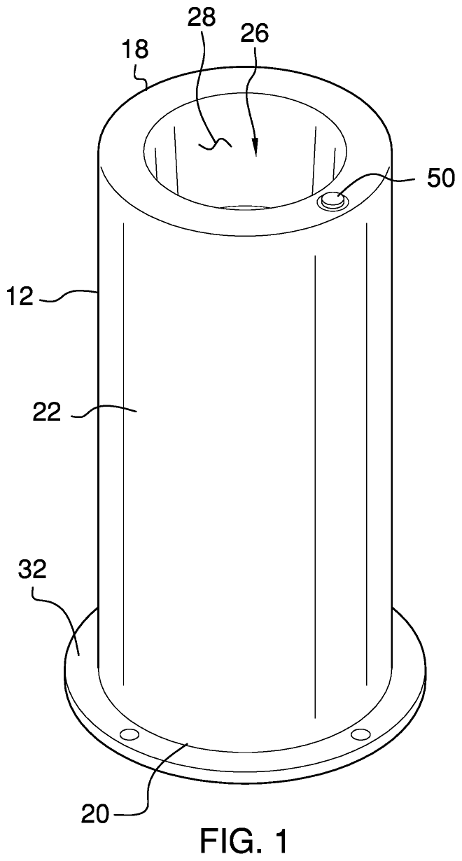

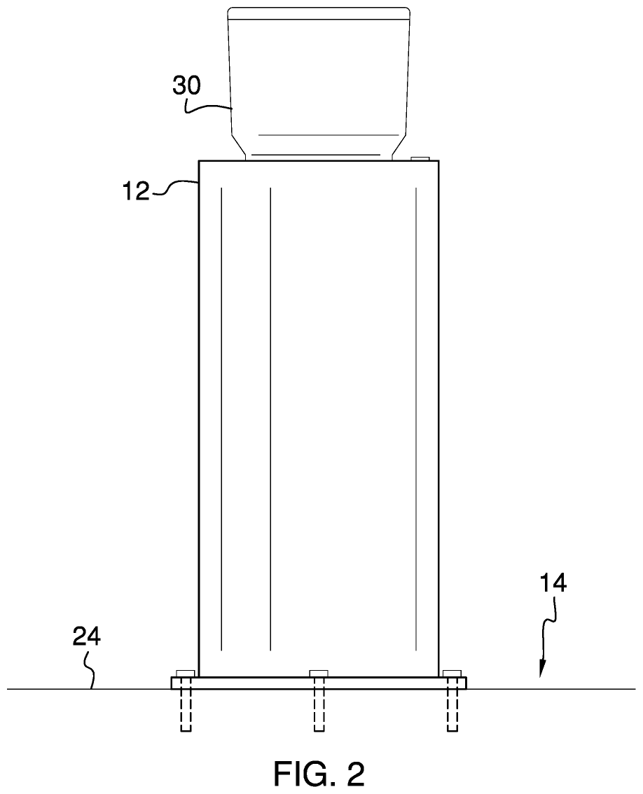

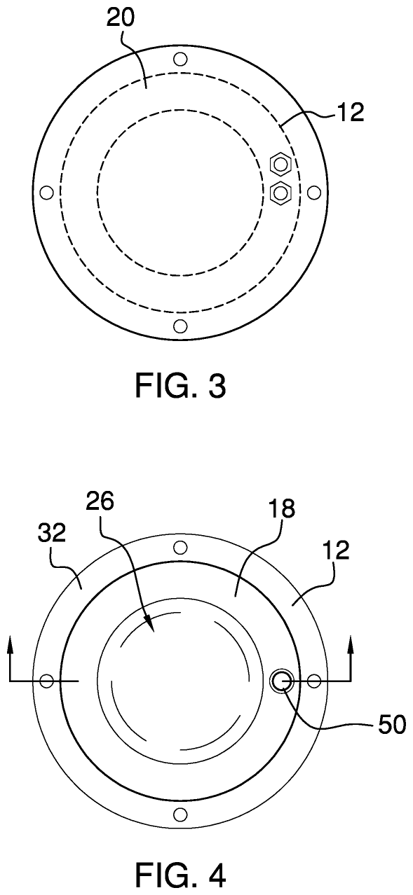

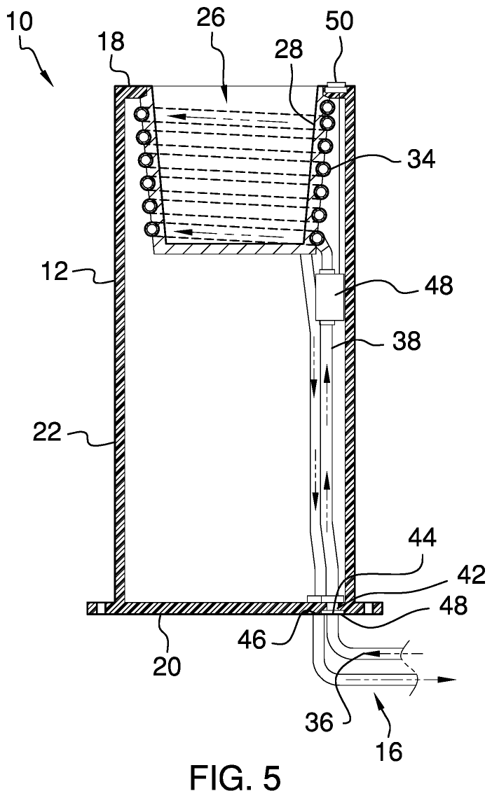

With reference now to the drawings, and in particular to FIGS. 1 through 5 thereof, a new warming device embodying the principles and concepts of an embodiment of the disclosure and generally designated by the reference numeral 10 will be described.

As best illustrated in FIGS. 1 through 5, the beverage warming assembly 10 generally comprises a receptacle 12 that is positioned within a vehicle 14. The vehicle 14 may be a passenger vehicle, a cargo vehicle, a construction vehicle and any other type of motorized vehicle that has a fluid cooling system 16. The receptacle 12 has a top end 18, a bottom end 20 and an outer wall 22 extending therebetween. The bottom end 20 is fastened to a support 24, such as a center consol of the vehicle 14, such that the receptacle 12 is vertically oriented and is accessible to a driver of the vehicle 14. The receptacle 12 may be a factory installed structure in the vehicle 14 or the receptacle may be an aftermarket structure for the vehicle 14.

The top end 18 has a well 26 extending toward the bottom end 20 and the well 26 has a bounding surface 28. The bounding surface 28 is continuous such that the well 26 has a cylindrical shape for insertably receiving a beverage container 30, such as a coffee mug or the like, and the beverage container 30 contains a hot beverage, such as coffee or the like. The receptacle 12 is comprised of a thermally conductive material such that the well 26 is in thermal communication with the beverage container 30. A flange 32 or the like may be coupled to the bottom end 20 of the receptacle for fastening the receptacle 12 to the vehicle 14.

A heating coil 34 is coupled to the receptacle 12 and the heating coil 34 is in thermal communication with the receptacle 12. The heating coil 34 is fluidly coupled to the fluid cooling system 16 of the vehicle 14 such that the heating coil 34 receives a heated fluid 36 from the fluid cooling system 16. In this way the heating coil 34 heats the beverage container 30 when the beverage container 30 is positioned in the receptacle 12. The heated fluid 36 may be antifreeze or other liquid coolant in the fluid cooling system 16. The heating coil 34 is wrapped around the well 26 such that the heating coil 34 is in thermal communication with the bounding surface 28. Additionally, the heating coil 34 comprises a conduit 38 that has an intake 40 and an outlet 42. The intake 40 is fluidly coupled to a supply line 44 of the fluid cooling system 16 and the outlet 42 is fluidly coupled to a return line 46 of the fluid cooling system 16.

A valve 48 is provided and the valve 48 is fluidly coupled to the heating coil 34. The valve 48 inhibits the heated fluid 36 from flowing through the heating coil 34 when the valve 48 is turned off. Moreover, the valve 48 facilitates the heated fluid 36 to flow through the heating coil 34 when the valve 48 is on. The valve 48 may be an electrically controlled fluid valve or the like. A button 50 is movably coupled to the receptacle 12 and the button 50 is electrically coupled to the valve 48 to turn the valve 48 on and off. The button 50 is in electrical communication with an electrical system of the vehicle 14.

In use, the intake 40 of the conduit 38 is fluidly coupled to the supply line 44 of the fluid cooling system 16 and the outlet 42 of the conduit 38 is fluidly coupled to the return line 46 of the fluid cooling system 16. The bottom end 20 of the receptacle 12 is fastened to the support 24 in the vehicle 14 and the beverage container 30 is selectively positioned in the well 26. The button 50 is manipulated to turn the valve 48 on thereby facilitating the heated fluid 36 to flow through the heating coil 34. Thus, the heated fluid 36 heats the heating coil 34 thereby facilitating the heating coil 34 to heat the beverage container 30 when the beverage container 30 is positioned in the well 26. In this way the heating coil 34 harnesses heat energy from the fluid cooling system 16 to retain the hot beverage in the beverage container 30 a hot temperature. The button 50 is manipulated to turn the valve 48 off at any time regardless of whether the beverage container 30 is positioned in the receptacle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage warming assembly being configured to heat a beverage container in a vehicle, said assembly comprising:
a receptacle being positioned within a vehicle wherein said receptacle is configured to insertably receive a beverage container; and
a heating coil being coupled to said receptacle, said heating coil being in thermal communication with said receptacle, said heating coil being fluidly coupled to a cooling system of the vehicle such that said heating coil receives a heated fluid from said cooling system wherein said heating coil is configured to heat the beverage container when the beverage container is positioned in said receptacle.

2. The assembly according to claim 1, wherein said receptacle has a top end, a bottom end and an outer wall extending therebetween, said top end having a well extending toward said bottom end, said well having a bounding surface, said bounding surface being continuous such that said well has a cylindrical shape wherein said well is configured to insertably receive a beverage container.

3. The assembly according to claim 2, wherein said receptacle is comprised of a thermally conductive material wherein said bounding surface of said well is configured to be in thermal communication with the beverage container.

4. The assembly according to claim 3, wherein said heating coil is wrapped around said well such that said heating coil is in thermal communication with said bounding surface.

5. The assembly according to claim 1, wherein said heating coil comprises a conduit having an intake and an outlet, said intake being fluidly coupled to a supply line of said cooling system, said outlet being fluidly coupled to a return line of said cooling system.

6. The assembly according to claim 5, further comprising a valve being fluidly coupled to said heating coil, said valve inhibiting said heated fluid from flowing through said heating coil when said valve is turned off, said valve facilitating said heated fluid to flow through said heating coil when said valve is on.

7. The assembly according to claim 6, further comprising a button being movably coupled to said receptacle, said button being electrically coupled to said valve such that said button turns said valve on and off, said button being in electrical communication with an electrical system of the vehicle.

8. A beverage warming assembly being configured to heat a beverage container in a vehicle, said assembly comprising:
a receptacle being positioned within a vehicle, said receptacle having a top end, a bottom end and an outer wall extending therebetween, said top end having a well extending toward said bottom end, said well having a bounding surface, said bounding surface being continuous such that said well has a cylindrical shape wherein said well is configured to insertably receive a beverage container, said receptacle being comprised of a thermally conductive material wherein said bounding surface of said well is configured to be in thermal communication with the beverage container;
a heating coil being coupled to said receptacle, said heating coil being in thermal communication with said receptacle, said heating coil being fluidly coupled to a cooling system of the vehicle such that said heating coil receives a heated fluid from said cooling system wherein said heating coil is configured to heat the beverage container when the beverage container is positioned in said receptacle, said heating coil being wrapped around said well such that said heating coil is in thermal communication with said bounding surface, said heating coil comprising a conduit having an intake and an outlet, said intake being fluidly coupled to a supply line of said cooling system, said outlet being fluidly coupled to a return line of said cooling system;
a valve being fluidly coupled to said heating coil, said valve inhibiting said heated fluid from flowing through said heating coil when said valve is turned off, said valve facilitating said heated fluid to flow through said heating coil when said valve is on; and
a button being movably coupled to said receptacle, said button being electrically coupled to said valve such that said button turns said valve on and off, said button being in electrical communication with an electrical system of the vehicle.
